(19) United States
(12) Patent Application Publication
(10) Pub. No.: US 2006/0137313 A1
(43) Pub. Date: Jun. 29, 2006

(54) Adjustable, self-cleaning rotary machine which is intended to produce a flow of purefied fluid

(76) Inventors: Francois Simon, Meudon (FR); Sandre Simon, Meudon (FR)

Correspondence Address: BROWDY AND NEIMARK, P.L.L.C.;624 NINTH STREET, NW, SUITE 300, WASHINGTON, DC, 20001-5303, US

(21) Appl. No.: 10/542,553

(22) PCT Filed: Dec. 30, 2003
(86) PCT No.: PCT/FR03/03946

§ 371 Date: Dec. 15, 2005

(30) Foreign Application Priority Data
Jan. 17, 2003 (FR) 03/00689

(51) Int. Cl. B01D 47/00

(52) U.S. Cl. 55/400

(57) ABSTRACT

The invention relates to a rotary machine comprising a rotor (6) bearing a packing (9) in the form of a ring which is at least partially made from a flexible, fluid-permeable material. The inventive machine also comprises variable-speed drive means for rotating the rotor (6) and means which enable the aforementioned packing (9) to be deformed in response to a variation in the rotational speed of the rotor (6). As a result, the machine can produce an air flow, extract material contained in said flow and perform a self-cleaning cycle.

The present invention relates to a rotary machine capable of generating the flow of a fluid flux, while simultaneously treating it by extracting materials contained in this flux and capable of releasing the retained materials during a self-cleaning process and the filtration performances of which may be adapted to variable needs very easily.

For example, it is applied to ventilation and purification (pollution control) of ambient air or exhaust gases of heat engines or to the separation of material transported by liquid effluents.

Generally, it is known that to generate an air flux at a pressure close to atmospheric pressure, fans (or suction devices) are notably used, which comprise a rotor driven by a motor and provided with blades or with a turbine which imparts to the fluid an increase in velocity on the one hand and, a diffuser on the other hand, which has the function of converting part of the kinetic energy into a further increase in pressure.

In spite of multiple expended efforts to reduce the noise, it is found that the presently proposed fans comprising centrifugal fans, remain noisy at medium or high rotational velocities. This is both due to the fact that the blades in a stiff material are the site of vibrations notably resulting from the presence of eccentric masses in the rotor, and/or from the action of the fluid on the blades and/or the turbulences generated by the blades.

Moreover, these fans are not able to provide by themselves a purification function for the transported fluid: to fulfill such a function, they are necessarily associated with purification devices such as filters in which the impurities are retained. Such is the case for home vacuum cleaners which comprise a chamber for filtering dusts in the suction circuit of the turbine.

The applicant has already proposed a rotary machine, the rotor of which comprises at least one fitting made in a material permeable to fluids, capable of driving the fluid into rotation which it contains so as to provide its ejection under the effect of the centrifugal force; the fitting according to a preferred embodiment consists of material consisting of looped fibers, the diameter of which is of the order of 0.1 to 5 mm; the aforesaid fitting is permanently attached to a disk or to a cage, rotatably mounted in a casing, and driven by a motor; the fluid is sucked through a circular port, not necessary coaxial, and is then delivered into the annular space partly surrounding the disk supporting the fitting, and flows in the direction of the discharge nozzle located at the end of said annular space.

Generally, it is known that the filtration efficiency of rotary machines such as the one described above, is defined as the % ratio of the deviation between the ambient particle concentration and the particle concentration at the output of these rotary machines, reduced to the ambient concentration, multiplied by 100.

Moreover, the aeraulic efficiency of these rotary machines is proportional to the ratio of the product of the pressure and of the flow rate of the fluid at the discharged nozzle, reduced to the mechanical power supplied to the rotor.

For given geometrical and physical characteristics of their fitting, the filtration efficiency of machines of the aforesaid type, change according to the rotational velocity of the fitting and to the size of the particles transported by the fluid.

When the rotational velocity of the fitting increases, the filtration efficiency increases for large particles (impact collection), whereas the filtration efficiency is reduced for small particles (flux entrainment effect).

When the rotational velocity of the fitting becomes very high, the filtration efficiency becomes negative for the small trapped particles following a release effect of said small particles; the same release effect occurs for the large trapped particles, at a low rotational velocity of the fitting or during stops and restarts.

As for the aeraulic efficiency, it increases with the rotational velocity of the fitting and then decreases beyond an optimum.

As a conclusion, for given geometrical and physical characteristics of a fitting, at a rotational velocity considered as optimum, there corresponds a maximum filtration efficiency for a given particle spectrum and it should correspond to a maximum aeraulic efficiency.

Now, it is found that it is not easy to obtain maximum filtration efficiency for the widest possible particle spectrum at a given rotational velocity, and this is all the less easy if, at this same rotational velocity, there should correspond a maximum aeraulic efficiency.

Moreover, clogging of the cavities of the fitting increases filtration efficiency to the detriment of the aeraulic efficiency, and there is a medium term risk of making the rotary machine inoperative; replacement of the fitting becomes essential.

The object of the invention is therefore to solve these difficulties by utilizing changes in the physical characteristics of the fitting (and consequently the change in the filtration efficiency), the aeraulic efficiency and the capacity of discharging trapped particles generated by variations of its rotational velocity.

It proposes the making of a sucking/discharging/operationally adjustable rotary machine with a very simple and not very costly design, which further is very silent, while providing by itself a treatment of the generated fluid flux, and capable of retaining or releasing at will the transported materials, during a self-cleaning process.

For this purpose, the rotary machine according to the invention comprises a rotor bearing a fitting in the form of a crown at least partly made in a flexible material, permeable to fluids, means for driving the rotor into rotation at a variable velocity, and means allowing for carrying out a deformation of the fitting in response to the variation of the rotating speed of the rotor.

Advantageously, the means for carrying out the aforesaid deformation involve a transmission device between the rotor and one of the cylindrical faces of the fitting, so that a change in the velocity of the rotor generates, under the effect of the change in the centrifugal force which results therefrom, compression and/or expansion of the fitting which is retained by the transmission means.

As an alternative, these means may involve a transmission device connecting the rotor to one of the two radial faces of the fitting, as well as an annular part permanently attached to the other radial face of the fitting, so that due to the inertia of this annular part, a change in the rotational velocity of the rotor generates a process of torsion and compression of the fitting (compression due to bringing both radial faces of the fitting together).

Of course, in one case as in the other, the fitting should be made in a sufficiently flexible permeable material so that by adjusting the rotational velocity, it is possible to obtain in steady flow conditions the desired filtration characteristics allowing particles in the desired dimensional range to be collected and, by varying the rotational velocity of the rotor, to obtain discharge of the previously collected particles and regeneration of the filtration characteristics.

Both of these solutions are particularly well suited to collecting mixtures of mists. For this purpose, the fitting may be made in an adsorbing material while means will be provided for spraying a liquid into the sucked air flux. Means will further be provided for collecting the liquid absorbed by the fitting and for ejecting it under the effect of the centrifugal force.

Embodiments of the invention will be described hereafter, as non-limiting examples, with reference to the appended drawings wherein:

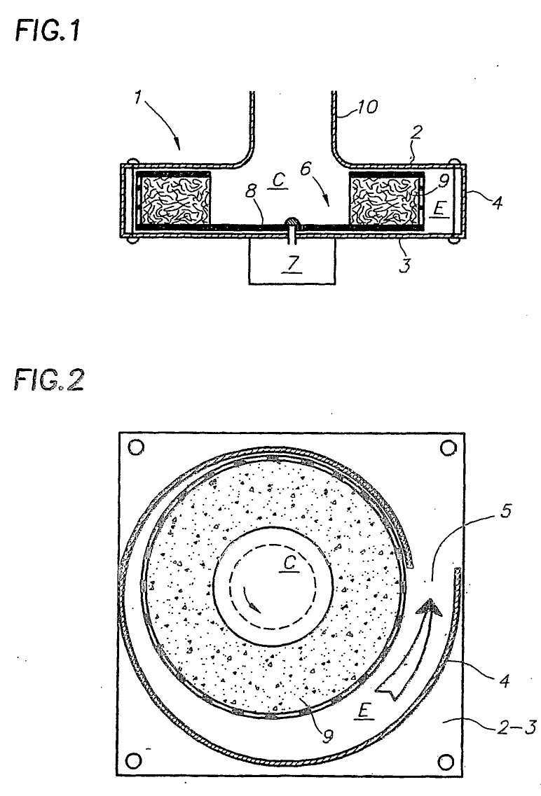

FIG. 1 is a schematic axial sectional view of a rotary machine for treating a gas such as ambient air;

FIG. 2 is a transverse sectional view of the machine illustrated in FIG. 1;

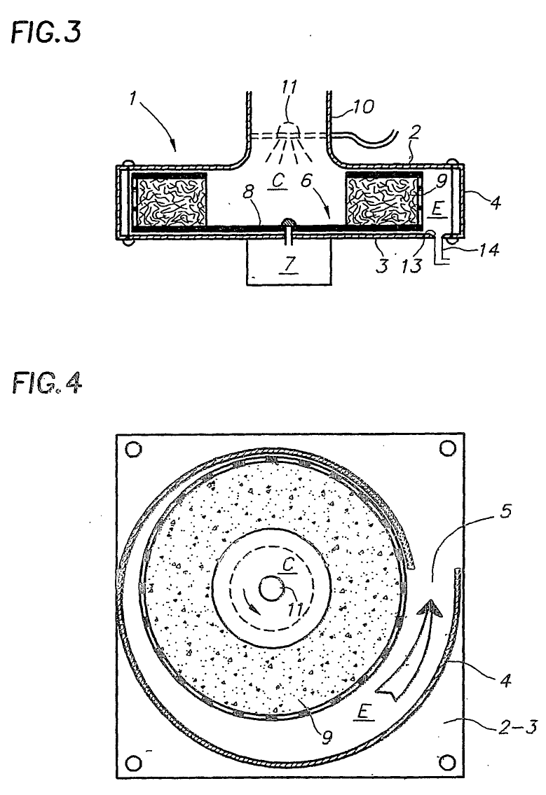

FIG. 3 is schematic axial sectional view of a first embodiment of the rotary machine for treating gases;

FIG. 4 is a transverse sectional view of the rotary machine illustrated in FIG. 3;

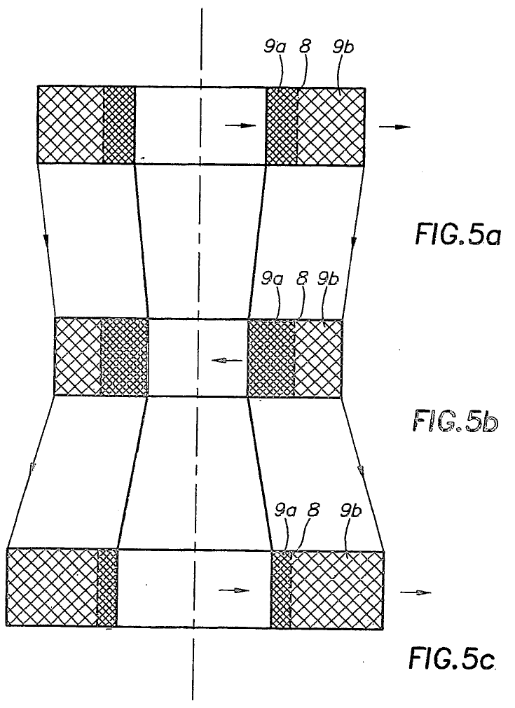

FIGS. 5a, 5b, 5c are a schematic illustration of a possible form of rotor in a flexible material permeable to fluids;

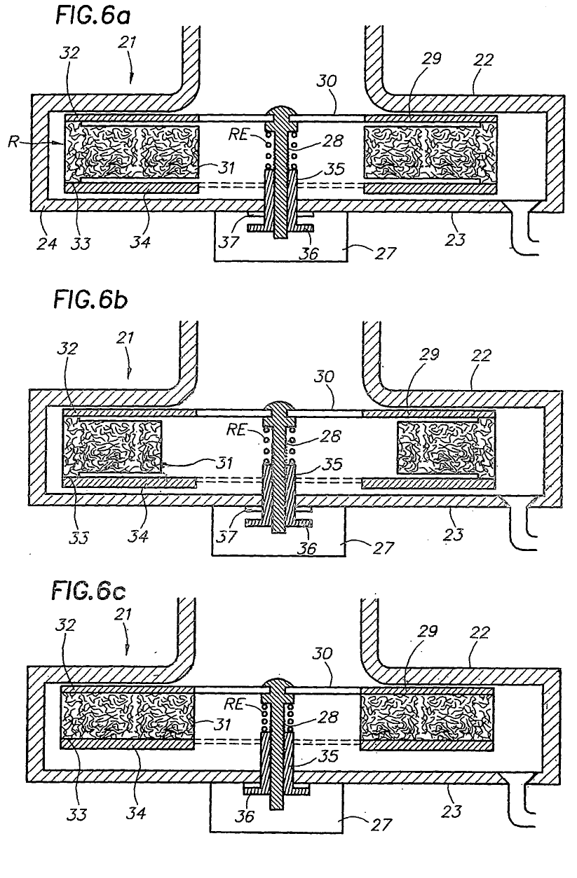

FIGS. 6a-6c are axial sectional views of a second embodiment of the rotary machine, in steady flow conditions, at a first rotational velocity (FIG. 6a), at a second rotational velocity (FIG. 6b) and in transient flow conditions during a sudden change in velocity (FIG. 6c).

In the example illustrated in FIGS. 1 and 2, the rotary treatment machine comprises a casing 1 comprising two coaxial parallel rectangular flanges 2, 3, connected to each other by a slightly helical transverse wall 4 which extends perpendicularly or obliquely relatively to both flanges. This wall 4 opens up outwards, through a side port 5. Optionally, it may have a concave, convex profile or one tilted relatively to the axis of rotation. Inside the casing, a rotor 6 is rotatably mounted with an axis perpendicular to both flanges 2, 3, and driven into rotation by an electric motor 7 permanently attached to the flange 3. This rotor is therefore at least partly encircled by the transverse wall 4.

In this example, the rotor 6 comprises a cage 8 in which a crown 9 permeable to air is contained. This crown 9 may be made in a flexible, reticular, and/or cellular material with open cells and/or in a fibrous or microfibrous material of natural origin, and/or a metal material, and/or a synthetic, hydrophilic and/or hydrophobic, oleophilic and/or oleophobic material, and/or coated with an adhesive substance.

The thickness of the cage 8 is substantially equal to the gap between both flanges 2, 3.

The flange 2 comprises at right angles to the cavity delimited by the crown, a circular port, not necessarily coaxial.

This port is extended with a tubular component 10 forming a suction nozzle.

The operation of this rotary machine is then as follows: the driving of the crown 9 into rotation by the motor 7 causes the air contained in this crown 9 to rotate. Under the effect of this rotation, the air mass subject to the centrifugal force flows into the space E between the crown 9 and the transverse partition 4 where it is guided towards the output port 5. In the same way, this flow causes air in the cavity C and in the nozzle 10 to be sucked and therefore generates a suction current.

Upon putting the crown 9 into rotation, the cells forming the material of the aforesaid crown 9, under the effect of the centrifugal force, stretch out in the area close to the axis of rotation, and are compressed in the peripheral area, close to the cage 8. Thus, a gradient of filtration characteristics is formed radially, allowing a large particle or mist spectrum or bubbles (liquid phase operation) to be collected for example. Thus, at the high rotational velocities of the crown 9, thereby promoting aeraulic efficiency, the filtration efficiency is increased peripherally, for particles of small dimensions, and retained for particles of large dimensions, at the internal face and/or in the bulk of the crown.

The air which flows out through port 5 is thereby purified.

Upon reducing the rotational velocity of the crown 9, below the rated rotational velocity, the cells forming the material of the aforesaid crown 9 resume their initial dimensions at a slow or zero rotational velocity, and notably those cells located in the periphery area, close to the cage 8. Thus, the particles trapped in said cells may escape through port E; the cleaning process is thereby applied, with a device for diverting the flux loaded with particles, as illustrated in FIGS. 1 and 2.

In the example illustrated in FIGS. 3 and 4, the treatment rotary machine comprises a casing 1 comprising two coaxial parallel rectangular flanges 2, 3, connected to each other by a slightly helical transverse wall 4 which extends perpendicularly or obliquely relatively to both flanges. This wall 4 opens up outwards, through a side port 5. Optionally, it may have a concave convex profile or one tilted relatively to the axis of rotation. Inside the casing 1, a rotor 6 with an axis perpendicular to both flanges 2, 3 is rotatably mounted and driven into rotation by an electric motor 7 permanently attached to the flange 3, this rotor is therefore at least partly encircled by the transverse wall 4.

Advantageously, the transverse wall 4 is provided with flutes directed downwards or with optionally helical or oblique relief features, either hydrophilic or hydrophobic, used for channelling the liquid in the desired direction.

In this example, the rotor 6 comprises a crown 8 in which a crown 9 permeable to air is located. This crown 9 may be made in a flexible, reticular and/or cellular material with open cells, and/or in a fibrous or microfibrous material of natural origin, and/or a metal and/or synthetic material and/or having antiseptic properties. Advantageously, it may have adsorption or catalytic properties.

The thickness of the crown 9+cage 8 assembly is substantially equal to the gap between both flanges 2, 3.

The flange 2 comprises, at right angles of the cavity delimited by the crown, a circular port not necessarily coaxial.

This port is extended by a tubular component 10 forming a suction nozzle.

This suction nozzle is fitted out with at least one head 11 for spraying a liquid such as water or oil.

The lower flange 3 further comprises a basin 13 with a small width which substantially extends along the transverse wall 4. One or more water (or oil) discharge ducts open into the bottom of this basin.

The operation of this rotary machine is then as follows: the driving of the crown 9 into rotation by the motor 7 causes the air contained in this crown 9 to rotate and the latter to deform. Under the effect of this rotation, the mass of air subject to the centrifugal force, flows into the space E between the crown 9 and the transverse wall 4 where it is guided towards the output port 5. In the same way, this flow causes air to be sucked into the cavity C and into the nozzle 10 and therefore generates a suction current. This suction current receives a mist of droplets coming from the sprayer 11. This mist generates a first phase for adsorbing impurities contained in the air.

During their passage in the crown 9, the droplets, loaded with impurities are adsorbed by the flexible material, permeable to fluids, while the air continues to be ejected outwards. These droplets, which are then channeled by the flexible (adsorbing) material, are then themselves also subject both to the centrifugal force and to gravity. They merge by coalescence along the fibers or on the walls of the cells, which generates their desorption. The resulting water (or oil) is ejected onto the transverse wall and flows along the aforesaid flutes or the aforesaid relief features in order to reach the basin 13 before being discharged through the ducts 14.

Upon putting the crown 9 into rotation, the walls of the cells, or the fibers, or the microfibers, forming the material of the aforesaid crown 9, under the effect of the centrifugal force, stretch out in the area close to the axis of rotation, and contract in the central area close the cage 8. Thus, the radii of curvature of the microfibers of the peripheral area decrease, which causes an increase of the wettability coefficient. A gradient of the filtration characteristics is formed radially, with progressive increase in the density of the network of the material, allowing a wide particle spectrum to be collected. Moreover, at the high rotational velocities of the crown 9 which thereby increase the aeraulic efficiency, the filtration efficiency is increased for particles of small dimensions and retained for particles of large dimensions.

The air which flows out through port 5 is thereby purified.

Upon reducing the rotational velocity of the crown 9, below the rated rotational velocity, the cells or the microfibers forming the material of the aforesaid crown 9 resume their initial dimensions at a slow or zero rotational velocity, and notably those located in the peripheral area, close to cage 8. Thus, the particles trapped in said cells will be able to escape through port E; the cleaning process is thereby applied with a device for diverting the flux loaded with particles, as illustrated in FIGS. 3 and 4.

Of course, the invention is not limited to the embodiments described earlier.

Thus, the fitting may have a composite structure. It may comprise two portions more or less permeable or impermeable to the displaced or propelled fluid, so as to direct the fluid into the mass or to increase the collection and/or aeraulic efficiency of the reticular mass or to discharge condensates, liquids, or bubbles (in a liquid phase). In particular, the crowns may consist of superimposed and/or concentric layers of different materials.

In the example illustrated in FIGS. 5a, 5b, 5c, the crown 9 consists of two concentric layers, located on either side of the cage 8.

The internal crown 9a is of the same nature of the one shown in the earlier examples; the external crown 9b consists of a material having larger cells than the one characterizing the material of the crown 9a; moreover, its radial thickness is larger than the one defining the internal crown 9a.

Upon putting crowns 9a and 9b (FIG. 5a) into rotation, the cells forming the material of the aforesaid crown 9a, under the effect of the centrifugal force, expand in an area close to the axis of rotation and contract in the peripheral area, close to the cage 8. The cells forming the material of the aforesaid crown 9b, under the effect of the centrifugal force, increasingly expand outwards. Thus, a gradient of filtration characteristics is formed radially by the crowns 9a and 9b allowing a very wide particle spectrum to be collected.

The air which flows out through port 5 is thereby purified.

Upon reducing the rotational velocity of the crowns 9a and 9b, below the rated rotational velocity (FIG. 5b), the cells forming the material of the aforesaid crowns 9a and 9b, resume their initial dimensions at zero rotational velocity, and notably those located in the peripheral area concerning the crown 9b. Thus, the particles, notably of large dimensions, trapped in said cells, may escape through port E.

Upon increasing the rotational velocity of the crowns 9a and 9b, beyond the rated rational velocity (FIG. 5c), the cells forming the material of the crown 9a will be compressed, whereas those of the crown 9b will stretch. Thus, the particles, notably of small dimensions, trapped in said cells, will be able to escape through port E.

The cleaning process is thereby applied by the compression and depression effect of crowns 9a and 9b at rotational velocities located on either side of the operating rated velocity by outward migration of the material retained by the crowns 9a and 9b.

This cleaning process is associated with a device for diverting the flux loaded with particles, not illustrated in FIGS. 5a, 5b, 5c.

Of course, the applications of the machines described above, may be very diverse: pump, vacuum cleaner, circulator, fan, blower, hair dryer, phases separator, . . .

In all these applications, with the rotary machine according to the invention, important simplifications may be provided and costs may be reduced. Taking into account the nature of the rotor (flexibility of the fitting), there is no risk to the user (as opposed to a conventional rotor with blades). Moreover, in order to avoid clogging of the fittings, a method consisting of rapidly varying the rotational velocity of the rotor allows the retained material to be released.

In the illustrated example in FIGS. 6a-6c, the rotary machine has a structure similar to that of the embodiment of FIGS. 1 and 2.

Indeed, it comprises a casing 21 comprising two coaxial rectangular flanges 22, 23, connected to each other by a slightly helical transverse wall 24 which extends perpendicularly or obliquely relative to both flanges 22, 23.

Inside the casing 21, a rotor R, with an axis perpendicular to both flanges 22, 23, is rotatably mounted and driven into rotation by an electric motor 27 permanently attached to the flange 23. This rotor R is therefore at least partly encircled by the transverse wall 24.

The rotor R comprises a central axis 28 which extends coaxially to the casing 21 and which is driven into rotation by the motor 27. This axis 28 itself drives in its upper portion a disk 29, having an apertured central portion 30. On this disk 29 is attached a fitting in the form of a crown 31, made in a flexible material, permeable to fluids, the attachment between the disk 29 and the fitting 31 being exclusively carried out at the external edge 32 of the radial faces of both of these components.

The fitting in the form of a crown 31 is made in a flexible material, for example with a reticular and/or cellular structure with open cells.

The external edge 33 of the lower face of the fitting 31 is connected to a massive annular part 34, optionally rotatably mounted with the possibility of axial displacement on the central axis 28 by means of a bearing 35.

The operation of this machine is then as follows: under steady state conditions (FIG. 6a), the motor 27 rotates at constant velocity. This rotation generates a flow of air through the fitting 31 and accordingly a process for filtering the thereby produced air current. The centrifugal force which is exerted on the fitting 31 causes a compression of the reticular of cellular material which determines the range of sizes of the particles which will be retained by this material.

Accordingly, the operator may adjust this rotational velocity according to the sizes of particles, for which filtration is desired (FIG. 6b).

Periodically, the fitting 31 may be cleaned so as to retain the filtration efficiency. For this purpose, it will be sufficient to cause a sudden change in the rotational velocity of the motor 27.

Indeed, this change has the effect of causing an angular shift between the driving disk 30 of the fitting 31 and the annular part 34 which because of its inertia exerts a resisting torque.

This angular shift causes torsion of the fitting 31 and a reduction in the distance between the disk 29 and the annular part 34 (FIG. 6c). A dual torsion/compression effect is obtained (like the one which is exerted on a floor cloth to extract the washing liquid) with additionally a flow of air through the fitting.

This dual portion/compression effect may be repeated by carrying out several successive changes in velocity, while providing between each change in velocity sufficient time to allow the fitting 31 to resume its initial position. A particularly efficient cleaning of the fitting 31 is thereby obtained.

Optionally, the central axis 28 may comprise a helical groove (threading) cooperating with a finger (or internal screw thread) provided in the bearing 35.

In this case, a change in velocity according to whether this is an increase or a decrease in the velocity may cause the disk 29 and the annular part 34 to be moved away from each other or to be brought closer to each other, and consequently an extension or a compression of the fitting 31.

According to another alternative embodiment of the invention, during the cleaning phases, the annular part 34 may be subject to vibrations, for example axial vibrations, by the action of a tooth 36 permanently attached to the bearing 35 pressing against a notched or corrugated annular surface 37 permanently attached to the casing 21 (FIG. 6c).

Controllable braking means may also be provided for braking the rotation of the annular part 34 and thereby increasing the torsion/compression effect.

Also, a compression spring RE may be interposed between the apertured central portion 30 and the annular part 34 or the bearing 35.

1-18. (canceled)

19. A rotary machine capable of generating a flux of fluid, comprising a rotor bearing a fitting in the form of a crown at least partly made in a flexible material, permeable to fluids, means for driving the rotor into rotation at a variable velocity,
said machine comprising self-cleaning means comprising as a combination:
control means capable of acting on the aforesaid means for driving the rotor into rotation at a variable velocity so as to generate a sudden change in the rotational velocity of said rotor,
coupling means between a first face of the fitting and the aforesaid driving means, and
an annular part borne by a second face of the fitting so that due to the inertia of this annular part, said sudden change in the rotational velocity of said rotor generates a process of torsion and/or compression of the fitting and consequently said self-cleaning of this fitting.

20. The machine according to claim 19, wherein the aforesaid fitting has the form of a crown contained in a cage.

21. The machine according to claim 19, wherein the aforesaid fitting has the form of a crown encircling a cage.

22. The machine according to claim 19, wherein the aforesaid fitting comprises two crowns, respectively contained in the aforesaid cage and encircling the aforesaid cage.

23. The machine according to claim 19, wherein the aforesaid annular part is rotatably mounted with the possibility of axial displacement on the axis for driving the rotor, by means of a bearing.

24. The machine according to claim 23, wherein the axis comprises a helical groove or threading cooperating with a finger or internal screw thread provided in the bearing.

25. The machine according to claim 23, comprising means for subjecting the annular part to vibrations.

26. The machine according to claim 23, comprising it comprises means for braking the annular part.

27. The machine according to claim 19, wherein the aforesaid fitting is made in a flexible, reticular and/or cellular material with open cells.

28. The machine according to claim 19, wherein the aforesaid fitting is made in a flexible fibrous or microfibrous material of natural origin and/or a metal and/or synthetic and/or antiseptic material.

29. The machine for extracting impurities contained in a gas according to claim 19,
wherein the aforesaid fitting is made in an adsorbing material and in that it further comprises a device for spraying a liquid into the air flux sucked up by the fitting on the one hand and means for collecting the liquid adsorbed by said fitting and ejected under the effect of the centrifugal force on the other hand.

30. The machine according to claim 29, wherein the aforesaid fitting rotates between two parallel flanges and in that the lower flange is provided with a basin into which at least one fluid discharge port opens.

31. The machine according to any of claims 29, wherein said flanges are connected together by a transverse wall which is provided with flutes directed downwards or relief features optionally helical or oblique used for channeling the liquid in a desired direction.

32. The machine according to claim 19, wherein a spring is interposed between both radial faces of the fitting.

33. The machine according to claim 19, wherein the aforesaid fitting has a composite structure comprising two portions more or less permeable or impermeable to the displaced or propelled fluid, so as to direct the fluid into the mass or to increase the collection and/or aeraulic efficiency of the reticular mass or to discharge condensates, liquids or bubbles (in the liquid phase).

34. The machine according to claim 19, wherein the aforesaid fitting comprises superimposed and/or concentric layers of different materials.
